(19) United States
(12) Patent Application Publication
(10) Pub. No.: US 2022/0283469 A1
(43) Pub. Date: Sep. 8, 2022

(54) ILLUMINATION DEVICE

(71) Applicant: HONDA MOTOR CO., LTD., Minato-ku, Tokyo (JP)

(72) Inventors: Toshiyuki Araki, Sendai-shi (JP); Masaru Ohira, Wako-shi (JP)

(21) Appl. No.: 17/630,224

(22) PCT Filed: Aug. 8, 2019
(86) PCT No.: PCT/JP2019/031491

§ 371 Date: Jan. 26, 2022

(51) Int. Cl. G02F 1/13357; F21V 8/00

(52) U.S. Cl. CPC G02F 1/133615; G02B 6/0066; G02F 1/133606

(57) ABSTRACT

An illumination device includes a display device, a light-guiding plate, a first coupling member disposed between the display device and the light-guiding plate, a transparent plate, a second coupling member disposed between the light-guiding plate and the transparent plate, and a light source. The light-guiding plate has a first surface in contact with the first coupling member and a second surface in contact with the second coupling member. The first surface is flat. The second surface has a flat part substantially parallel to the display surface and a convex portion that projects from the flat part to the second coupling member side. The convex portion has a first portion inclined to the second coupling member side from upstream to downstream in an emission direction of the light source, and a second portion inclined to the first coupling member side from upstream to downstream in the emission direction.

### TECHNICAL FIELD

The present invention relates to an illumination device.

### BACKGROUND ART

Conventionally, as an illumination device having a display device such as a liquid crystal display, a front light-type illumination device and a backlight-type illumination device are known. Since the front light-type illumination device does not consume power when there is external light, it consumes less power than the backlight-type illumination device. In recent years, various technologies for improving the performance when displaying characters, images, and the like have been proposed in this front light-type illumination device.

For example, Patent Literature 1 (Japanese Unexamined Patent Application First Publication No. 2002-365620) discloses a configuration of a liquid crystal display device that includes a light-guiding plate having a prism on the outer surface, a liquid crystal panel, an adhesive disposed between the light-guiding plate and the liquid crystal panel, and a gap holding material disposed on the outer circumference portion of the adhesive. The gap holding material makes it easier to spread an adhesive applied on the inside toward the outside. As a result, it has been reported that air bubbles remaining when the light-guiding plate and the liquid crystal panel are bonded together can be inhibited, and a display quality of a displayed image can be improved.

### SUMMARY OF INVENTION

### Technical Problem

However, in the technology described in Patent Literature 1, since a prism is disposed on an outer surface of the light-guiding plate to guide light from a light source to a display surface side, there is a problem that an image contrast may be deteriorated due to scattering of external light. In addition, there is a problem that an appearance quality of an image may be deteriorated due to an occurrence of an interference color (rainbow unevenness) of a prism. Furthermore, since the prism of the light-guiding plate is exposed, there has been also a problem in terms of durability.

An object of the present invention is to provide an illumination device having a front light-type display device, which suppresses occurrence of image contrast deterioration or rainbow unevenness and has improved durability.

### Solution to Problem

In the illumination device according to the present invention, the following configuration will be adopted to solve the problems described above.

(1) An illumination device of one aspect of the present invention includes a display device that has a display surface, a light-guiding plate disposed on the display surface side of the display device, a first coupling member disposed between the display device and the light-guiding plate, a transparent plate disposed on a side of the light-guiding plate, which is opposite to the display device, a second coupling member disposed between the light-guiding plate and the transparent plate, and a light source configured to emit light such that a lateral surface of the light-guiding plate is illuminated, in which the light-guiding plate has a first surface in contact with the first coupling member, and a second surface in contact with the second coupling member, the first surface of the light-guiding plate is flat, the second surface of the light-guiding plate has a flat part substantially parallel to the display surface and a convex portion that projects from the flat part to the second coupling member side, the convex portion has a first portion inclined to the second coupling member side from upstream to downstream in an emission direction of the light source, and a second portion inclined to the first coupling member side from upstream to downstream in the emission direction, the light-guiding plate is formed to cause, in the second portion, the light emitted from the light source and reaching the second surface to be totally reflected, cause the light totally reflected by the second portion to exit from the first surface to the outside of the light-guiding plate, and cause the light totally reflected by the second portion to pass through the first surface, and, when a refractive index of the first coupling member and the second coupling member is set to n1, a refractive index of the light-guiding plate is set to n2, an angle of the light propagating in the light-guiding plate with respect to the display surface is set to a, an inclination angle of the second portion with respect to the display surface is set to β, and a reflection angle of the light totally reflected by the second portion with respect to the display surface is set to γ, α+β≤90°−arcsin (n1/n2) and γ≤α+2β are satisfied.

(2) An illumination device according to another aspect of the present invention includes a display device that has a display surface, a light-guiding plate disposed on the display surface side of the display device, a first coupling member disposed between the display device and the light-guiding plate, a transparent plate disposed on a side of the light-guiding plate, which is opposite to the display device, a second coupling member disposed between the light-guiding plate and the transparent plate, and a light source configured to emit light such that a lateral surface of the light-guiding plate is illuminated, in which the light-guiding plate has a first surface in contact with the first coupling member, and a second surface in contact with the second coupling member, the first surface of the light-guiding plate is flat, the second surface of the light-guiding plate has a flat part substantially parallel to the display surface and a convex portion that projects from the flat part to the second coupling member side, and the convex portion has a first portion inclined to the second coupling member side from upstream to downstream in an emission direction of the light source, and a second portion inclined to the first coupling member side from upstream to downstream in the emission direction.

(3) In the illumination device according to the aspect of (2) described above, the light-guiding plate may be formed to cause, in the second portion, the light emitted from the light source and reaching the second surface to be totally reflected, and cause the light totally reflected by the second portion to exit from the first surface to the outside of the light-guiding plate.

(4) In the illumination device according to the aspect of (3) described above, the light-guiding plate may be formed to cause the light totally reflected by the second portion to pass through the first surface.

(5) In the illumination device according to any aspect of (2) to (4) described above, when a refractive index of the first coupling member and the second coupling member is set to n1, a refractive index of the light-guiding plate is set to n2, an angle of the light propagating in the light-guiding plate with respect to the display surface is set to α, an inclination angle of the second portion with respect to the display surface is set to β, and a reflection angle of the light totally reflected by the second portion with respect to the display surface is set to γ, α+β≤90°−arcsin(n1/n2), and γ≤α+2β may be satisfied.

### Advantageous Effects of Invention

According to the aspects of (1) and (2) described above, light incident on the light-guiding plate from the light source is reflected by the second portion provided on the second surface of the light-guiding plate, and is then incident on the first coupling member from the first surface. After that, the light is incident on the display device by passing through the first coupling member, is incident on the light-guiding plate again as light containing the display contents, and exits from the upper surface of the transparent plate by passing through the second coupling member and the transparent plate from the second surface of the light-guiding plate. The light exiting from the upper surface of the transparent plate is observed by the eyes of an observer. As the light takes such a path, it is possible to illuminate the display device with the light from the light source disposed on a side of the light-guiding plate, and to improve image contrast by suppressing the scattering of external light. In addition, it is possible to suppress the occurrence of an interference color (rainbow unevenness) of light, and improve the appearance quality of an image.

Since the transparent plate is disposed on the upper surface of the light-guiding plate via the second coupling member, the light-guiding plate can be protected by the transparent plate as compared with a case where the convex portion of the light-guiding plate is exposed. As a result, the deterioration of the light-guiding plate over time can be suppressed and the durability of the light-guiding plate can be improved. In addition, since the performance of the light-guiding plate can be maintained at a high level, the lifespan of the illumination device can be improved. Furthermore, since an influence of external light can be suppressed as compared with the case where the convex portion of the light-guiding plate is exposed, it is possible to suppress the deterioration in image contrast and the occurrence of rainbow unevenness, and to uniformly illuminate the entire display surface.

Therefore, in the illumination device having a front light-type display device, it is possible to provide an illumination device with improved durability by suppressing the deterioration in image contrast and the occurrence of rainbow unevenness.

According to the aspects (1) and (3) described above, the light incident on the light-guiding plate from the light source is totally reflected by the second portion, and the totally reflected light exits from the first surface toward the display surface side. In this manner, since the light is totally reflected by the second surface of the light-guiding plate and then exits, the utilization rate of the light from the light source can be improved.

According to the aspects (1) and (4) described above, the light incident on the light-guiding plate from the light source is totally reflected by the second portion, and then exits to the display surface by passing through the first surface. Therefore, the utilization rate of the light from the light source can be improved.

According to the aspects (1) and (5) described above, light can be efficiently totally reflected by the second portion. In addition, light including the display contents can exit within a range observable by the eyes of an observer. Therefore, it is possible to improve the utilization efficiency of the light from the light source and to obtain an illumination device with excellent display performance.

### BRIEF DESCRIPTION OF DRAWINGS

FIG. 1 is a two-surface diagram of an illumination device according to an embodiment.

FIG. 2 is an enlarged view of a part II of FIG. 1.

### DESCRIPTION OF EMBODIMENTS

[Illumination Device]

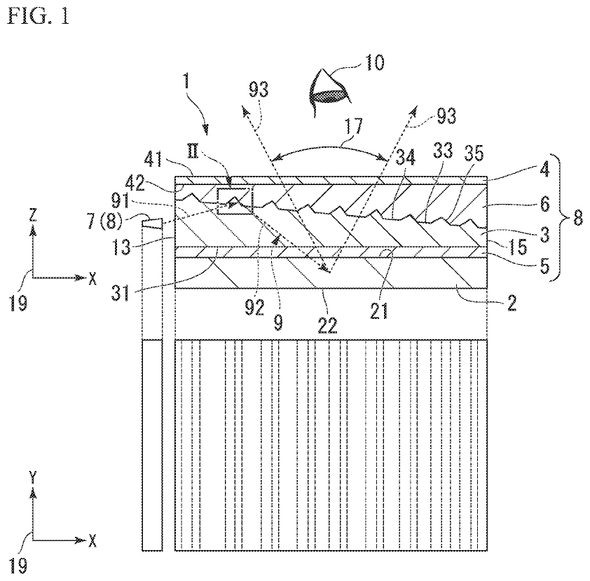

FIG. 1 is a two-surface view of the illumination device 1 according to an embodiment.

The illumination device 1 is an illumination device 1 including a front light-type display device 2 (for example, a front light illumination-type reflective liquid crystal display). In the front light-type illumination device 1, unlike a backlight-type illumination device 1, a light source 7 does not need to emit light at all times, so that the power consumption is low. Such a front light-type illumination device 1 (hereinafter, it may be simply referred to as an illumination device 1) having low power consumption is used in, for example, a bicycle, a two-wheeled vehicle, an automobile, a train, a ship, an airplane, a mountain climbing tool, or the like.

The illumination device 1 includes a display device 2 and a lighting structure 8.

The display device 2 is a display device 2 such as a reflective liquid crystal display. The display device 2 has a display surface 21 on which the display contents are displayed and a back surface 22 on an opposite side thereof.

The lighting structure 8 is disposed on the display surface 21 side of the display device 2. The lighting structure 8 has a light-guiding plate 3, a transparent plate 4, a first coupling member 5, a second coupling member 6, and a light source 7.

[Light-Guiding Plate]

The light-guiding plate 3 is disposed so as to face the display surface 21 of the display device 2. The light-guiding plate 3 is formed of a resin material such as polycarbonate. A refractive index n2 of the light-guiding plate 3 is, for example, 1.585. The light-guiding plate 3 has a first surface 31 facing the display device 2 side and a second surface 33 on a side opposite to the first surface 31. The first surface 31 is flat. As a result, the first surface 31 is disposed substantially parallel to the display surface 21 of the display device 2. The first surface 31 faces the display surface 21 at intervals. The second surface 33 has a flat part 34 and a convex portion 35.

The flat part 34 is substantially parallel to the display surface 21 of the display device 2. To be substantially parallel means that, for example, an angle between the flat part 34 and the display surface 21 is equal to or less than 1°. More specifically, in the present embodiment, the flat part 34 is gently inclined from one lateral surface 13 of the light-guiding plate 3 toward the other lateral surface 15 when viewed from a side orthogonal to a plane direction of the first surface 31. An inclination angle of the flat part 34 with respect to the display surface 21 is equal to or less than 1°.

The convex portion 35 is formed so as to project from the flat part 34 toward a side opposite to the display device 2. A plurality of convex portions 35 are provided side by side in an inclination direction of the flat part 34. The convex portion 35 extends in a direction substantially parallel to the one lateral surface 13 of the light-guiding plate 3 (a Y-axis direction of an orthogonal coordinate system 19). As a result, the convex portion 35 and the flat part 34 are alternately disposed in directions each orthogonal to the one lateral surface 13 and the first surface 31 of the light-guiding plate 3 (an X-axis direction of the orthogonal coordinate system 19). A height dimension of the convex portion 35 with respect to the flat part 34 is, for example, about 10 μm. The convex portion 35 is formed to be in a triangular shape.

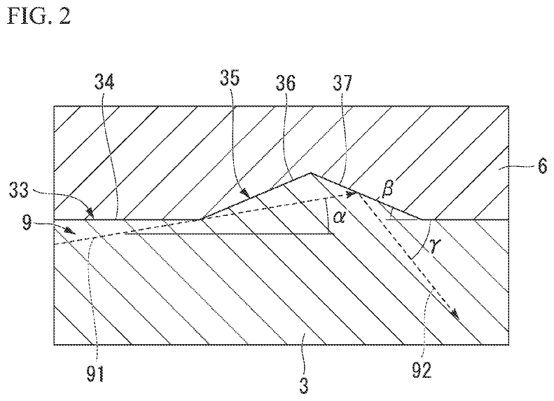

FIG. 2 is an enlarged view of a part II of FIG. 1. In FIG. 2, for a sake of simplicity, the flat part 34 of the second surface 33 in the light-guiding plate 3 is shown to be parallel to the display surface 21 of the display device 2. In this case, it is assumed that the first surface 31 of the light-guiding plate 3 is also parallel to the display surface 21.

The convex portion 35 has a first portion 36 and a second portion 37.

The first portion 36 is inclined toward the side opposite to the display device 2 as it heads from the one lateral surface 13 to the other lateral surface 15 of the light-guiding plate 3. An inclination angle of the first portion 36 with respect to a horizontal plane (that is, the inclination angle with respect to the display surface 21 in the present embodiment) is set to be an angle larger than an angle α of light emitted from the light source 7 to the second surface 33, which will be described in detail below.

The second portion 37 is inclined toward the display device 2 side as it heads from the one lateral surface 13 to the other lateral surface 15 of the light-guiding plate 3. An inclination angle of the second portion 37 with respect to the horizontal plane (that is, an inclination angle with respect to the display surface 21 in the present embodiment) is set to be β.

In this manner, the convex portion 35 formed by the first portion 36 and the second portion 37 functions as a prism of the light-guiding plate 3.

[Transparent Plate]

Returning to FIG. 1, the transparent plate 4 is disposed on a side of the light-guiding plate 3, which is opposite to the display device 2. The transparent plate 4 is a flat plate having an upper surface 41 (a surface opposite to the light-guiding plate 3) and a lower surface 42 (a surface facing the light-guiding plate 3) formed to be flat. The transparent plate 4 is disposed substantially parallel to the display surface 21 of the display device 2. The transparent plate 4 is disposed to face the second surface 33 of the light-guiding plate 3 at intervals. The upper surface 41 of the transparent plate 4 faces the outside (atmosphere). The transparent plate 4 is, for example, formed of a material such as a hard glass. The transparent plate 4 is, for example, a protective glass, a touch panel, or the like. The refractive index n3 of the transparent plate 4 is, for example, 1.52. The transparent plate 4 formed in this manner serves to flatten a surface of the illumination device 1 and to protect the light-guiding plate 3 by covering an uneven shape formed on the second surface 33 of the light-guiding plate 3.

[First Coupling Member]

The first coupling member 5 is disposed between the display device 2 and the light-guiding plate 3. The first coupling member 5 is in contact with both the display surface 21 of the display device 2 and the first surface 31 of the light-guiding plate 3, respectively. The first coupling member 5 is, for example, a cured adhesive used for bonding the display device 2 to the light-guiding plate 3. The first coupling member 5 is, for example, silicone. A refractive index n1 of the first coupling member 5 is, for example, 1.41.

[Second Coupling Member]

The second coupling member 6 is disposed between the light-guiding plate 3 and the transparent plate 4. The second coupling member 6 is in contact with both the second surface 33 of the light-guiding plate 3 and the lower surface 42 of the transparent plate 4, respectively. A lower surface of the second coupling member 6 (a surface facing the light-guiding plate 3) is formed to be in an uneven shape corresponding to an uneven shape of the light-guiding plate 3. The second coupling member 6 is, for example, a cured adhesive used for bonding the light-guiding plate 3 to the transparent plate 4. The first coupling member 5 and the second coupling member 6 are made of the same material. That is, a refractive index n1 of the second coupling member 6 is 1.41. In this manner, the refractive index n1 of the second coupling member 6 is lower than the refractive index n2 of the light-guiding plate 3 and the refractive index n3 of the transparent plate 4.

The refractive indices of the second coupling member 6 and the light-guiding plate 3 may be different values. For example, the refractive index n1 of the second coupling member 6 may be set to an arbitrary value in a range of 1.3n1<1.5. In addition, for example, the refractive index n2 of the light-guiding plate 3 may be set to an arbitrary value in a range of 1.5n21.7. Moreover, for example, the refractive index n3 of the transparent plate 4 may be set to an arbitrary value within a range of 1.3n31.7. As a difference between the refractive index n1 of the second coupling member 6 and the refractive index n2 of the light-guiding plate 3 is larger, an utilization efficiency of illumination is increased. Furthermore, the first coupling member 5 and the second coupling member 6 may be made of different materials.

[Light Source]

The light source 7 is disposed to illuminate the one lateral surface 13 of the light-guiding plate 3. Specifically, the light source 7 is disposed along the one lateral surface 13 of the light-guiding plate 3 to illuminate the one lateral surface 13 as a whole, and to cause light 9 to be incident on an inside of the light-guiding plate 3 in a direction from the one lateral surface 13 to the other lateral surface 15. Here, when external light reaching the display device 2 is strong, display contents of the display device 2 can be read by the external light. On the other hand, when the external light reaching the display device 2 is weak, the display contents of the display device 2 can be read by the light 9 from the light source 7.

[Optical Path]

Next, a path (an optical path) of the light 9 emitted from the light source 7 will be described.

The light 9 is incident from the one lateral surface 13 of the light-guiding plate 3 and travels in the light-guiding plate 3. At this time, an emission angle of the light 9 with respect to the display surface 21 is set to be α (refer to FIG. 2). The light 9 (91) having exited from the light source 7 into the light-guiding plate 3 is totally reflected by the second portion 37 of the convex portion 35 when it first reaches the second surface 33 of the light-guiding plate 3, and travels toward the first surface 31 of the light-guiding plate 3. The light 9 is totally reflected by the second portion 37 of the convex portion 35, and thereby the light 9 changes a direction to approach a normal line of the light-guiding plate 3.

After that, when the light 9 (92) totally reflected by the second portion 37 reaches the first surface 31 of the light-guiding plate 3, it exits from the first surface 31 to the outside of the light-guiding plate 3 by passing through the first surface 31, and, at the same time, is incident on the first coupling member 5. After that, the light 9 (92) is incident on the display device 2, exits from an upper surface of the transparent plate 4 as light 9 (93) including the display contents in a range indicated by an arrow 17, and is observed by the eyes 10 of an observer. As the light 9 takes such a path, an image contrast is improved when the light 9 from the light source 7 illuminates the display device 2. In addition, since the incident light on the light-guiding plate 3 follows such a path, an utilization efficiency of the light 9 of the light source 7 is improved.

Here, as shown in FIG. 2, an angle formed by light 9 (91) having exiting from the light source 7 and traveling in the light-guiding plate 3 with the display surface 21 is set to α. An angle formed between the second portion 37 and the display surface 21 is set to β. At this time, α and β are set to satisfy Equation (1) using the refractive index n1 of the second coupling member 6 and the refractive index n2 of the light-guiding plate 3.

α+β≤90°−arcsin(n1/n2) Equation (1)

By satisfying Equation (1), the light 9 (91) having exited from the light source 7 is totally reflected by the second portion 37.

Furthermore, an angle formed by the light 9 (92), which is totally reflected by the second portion 37 and heads toward the first surface 31, with the display surface 21 is set to γ. At this time, γ is determined to satisfy Equation (2) using the α and β described above.

γ≤α+2β Equation (2)

### Action and Effect

Next, action and effect of the illumination device 1 described above will be described.

According to the illumination device 1 of the present embodiment, the light 9 (91) incident on the light-guiding plate 3 from the light source 7 is reflected by the second portion 37 provided on the second surface 33 of the light-guiding plate 3, and is incident on the first coupling member 5 from the first surface 31. After that, the light 9 is incident on the display device 2 by passing through the first coupling member 5, is incident on the light-guiding plate 3 again as the light 9 (93) including the display contents, and exits from the upper surface 41 of the transparent plate 4 by passing through the second coupling member 6 and the transparent plate 4 from the second surface 33 of the light-guiding plate 3. The light 9 (93) having exited from the upper surface 41 of the transparent plate 4 is observed by the eyes 10 of an observer. As the light 9 takes such a path, it is possible to illuminate the display device 2 with the light 9 from the light source 7 disposed on a side of the light-guiding plate 3. Here, since the upper surface 41 of the transparent plate 4 provided on the eyes 10 side of an observer is formed to be flat, deterioration of the image contrast due to scattering of external light can be suppressed. In addition, deterioration of an appearance quality of a displayed image due to an interference color (rainbow unevenness) of the prism of the light-guiding plate 3 can be suppressed. For this reason, it is possible to improve the image contrast, suppress the occurrence of an interference color (rainbow unevenness) of light, and improve the appearance quality of an image.

Since the transparent plate 4 is disposed on the second surface 33 side of the light-guiding plate 3 via the second coupling member 6, the light-guiding plate 3 can be protected by the transparent plate 4 as compared with the case where the light-guiding plate 3 is exposed to the outside. As a result, deterioration of the light-guiding plate 3 over time can be suppressed, and durability of the light-guiding plate 3 can be improved. Moreover, since the performance of the light-guiding plate 3 can be maintained at a high level, the life of the illumination device 1 can be improved. Furthermore, since the second coupling member 6 and the transparent plate 4 are laminated and flattened so as to fill an uneven shape formed on the second surface 33 of the light-guiding plate 3, the scattering of external light can be suppressed as compared with the case where the convex portion 35 of the light-guiding plate 3 is exposed. Accordingly, it is possible to suppress the deterioration of an image contrast and the occurrence of rainbow unevenness, and uniformly illuminate the entire display surface 21.

Therefore, in the illumination device 1 having the front light-type display device 2, it is possible to provide the illumination device 1 with improved durability by suppressing the deterioration in image contrast and the occurrence of rainbow unevenness.

The light 9 (91) incident on the light-guiding plate 3 from the light source 7 is totally reflected by the second portion 37, and the totally reflected light 9 (93) exits from the first surface 31 toward the display surface 21 side. In this manner, since the light 9 is totally reflected by the second surface 33 of the light-guiding plate 3 and exits, the utilization rate of the light 9 from the light source 7 can be improved.

In addition, the light 9 (91) incident on the light-guiding plate 3 from the light source 7 is totally reflected by the second portion 37, and then exits to the display surface 21 by passing through the first surface 31. For this reason, the utilization rate of the light 9 from the light source 7 can be improved.

A refractive index of the second coupling member 6 is set to n1, a refractive index of the light-guiding plate 3 is set to n2, an angle of the light 9 (91) propagating in the light-guiding plate 3 with respect to the display surface 21 is set to a, and an inclination angle of the second portion 37 with respect to the display surface 21 is set to β, and a reflection angle of the light 9 (92) totally reflected by the second portion 37 with respect to the display surface 21 is set to γ, α, β, and γ satisfy Equation (1) and Equation (2), respectively. As a result, the light 9 can be efficiently totally reflected in the second portion 37. In addition, the light 9 (93) including the display contents can exit within a range observable by the eyes 10 of an observer. For this reason, the utilization efficiency of the light 9 from the light source 7 can be improved, and the illumination device 1 with excellent display performance can be obtained.

A technical scope of the present invention is not limited to the embodiment described above, and various changes can be made within a range not departing from the spirit of the present invention.

For example, in the embodiment described above, the first coupling member 5 is joined to the display surface 21 of the display device 2, but a film or the like for improving the utilization efficiency of light may be disposed between the first coupling member 5 and the display surface 21.

In addition, it is possible to replace the components in the embodiment described above with known components as appropriate within the range not departing from the spirit of the present invention, and the embodiments described above may be combined as appropriate.

### INDUSTRIAL APPLICABILITY

According to the illumination device 1 described above, in an illumination device having a front light-type display device, it is possible to suppress the deterioration in image contrast and the occurrence of rainbow unevenness, and to improve durability.

Here, in a display for outdoor use that is exposed to strong external light such as sunlight, there is a problem that image light loses to the strong external light and becomes invisible in the backlight-type transmissive liquid crystal display represented by smartphones. A reflective liquid crystal display without an illumination device is sufficient for use only in the strong external light, but an image is required to be visible in the dark in most display applications today.

According to the front light-type reflective liquid crystal display using the illumination device 1 described above, the deterioration of an image (scattering of external light by a prism and rainbow unevenness due to interference) is suppressed, and the light-guiding plate 3 is protected by the transparent plate 4, which can improve the durability, and the performance of the light-guiding plate 3 does not change even if a touch panel or the like is attached to an upper surface of the light-guiding plate 3. Furthermore, since there is no need for illumination if there is external light, the power consumption is reduced to 1/50 as compared to that of the backlight-type transmissive liquid crystal display, and it is a display that can be used without an excess or deficiency for the first time in both of bright places with strong external light and dark places without external light. As a result, it can be applied to the following special applications. Specifically, it can be applied to, for example, outdoor digital signage, bicycles, automobiles, two-wheeled vehicles, heavy machinery, ships, aircraft, terminals for mountain climbing where power supply is difficult, terminals at the time of disaster, tablet PCs at construction sites, gas/electricity/water inspection terminals, courier terminals, and the like, and can be an illumination device 1 that will be used worldwide for a long period of time.

### REFERENCE SIGNS LIST

1 Illumination device
2 Display device
3 Light-guiding plate
4 Transparent plate
5 First coupling member
6 Second coupling member
7 Light source
9 Light
13 One lateral surface (lateral surface of light-guiding plate)
21 Display surface
31 First surface
33 Second surface
34 Flat part
35 Convex portion
36 First portion
37 Second portion

1. An illumination device comprising:
a display device that has a display surface;
a light-guiding plate disposed on the display surface side of the display device;
a first coupling member disposed between the display device and the light-guiding plate;
a transparent plate disposed on a side of the light-guiding plate, which is opposite to the display device;
a second coupling member disposed between the light-guiding plate and the transparent plate; and
a light source configured to emit light such that a lateral surface of the light-guiding plate is illuminated,
wherein the light-guiding plate has a first surface in contact with the first coupling member, and a second surface in contact with the second coupling member,
the first surface of the light-guiding plate is flat,
the second surface of the light-guiding plate has a flat part substantially parallel to the display surface and a convex portion that projects from the flat part to the second coupling member side,
the convex portion has a first portion inclined to the second coupling member side from upstream to downstream in an emission direction of the light source, and a second portion inclined to the first coupling member side from upstream to downstream in the emission direction,
the light-guiding plate is formed to cause, in the second portion, the light emitted from the light source and reaching the second surface to be totally reflected, cause the light totally reflected by the second portion to exit from the first surface to the outside of the light-guiding plate, and cause the light totally reflected by the second portion to pass through the first surface, and
when a refractive index of the first coupling member and the second coupling member is set to n1, a refractive index of the light-guiding plate is set to n2, an angle of the light propagating in the light-guiding plate with respect to the display surface is set to a, an inclination angle of the second portion with respect to the display surface is set to β, and a reflection angle of the light totally reflected by the second portion with respect to the display surface is set to γ, α+β≤90°−arcsin(n1/n2), and γ≤α+2β are satisfied.

2. An illumination device comprising:
a display device that has a display surface;
a light-guiding plate disposed on the display surface side of the display device;
a first coupling member disposed between the display device and the light-guiding plate;
a transparent plate disposed on a side of the light-guiding plate, which is opposite to the display device;
a second coupling member disposed between the light-guiding plate and the transparent plate; and
a light source configured to emit light such that a lateral surface of the light-guiding plate is illuminated,
wherein the light-guiding plate has a first surface in contact with the first coupling member, and a second surface in contact with the second coupling member,
the first surface of the light-guiding plate is flat,
the second surface of the light-guiding plate has a flat part substantially parallel to the display surface and a convex portion that projects from the flat part to the second coupling member side, and
the convex portion has a first portion inclined to the second coupling member side from upstream to downstream in an emission direction of the light source, and a second portion inclined to the first coupling member side from upstream to downstream in the emission direction,

3. The illumination device according to claim 2,
wherein the light-guiding plate is formed to cause, in the second portion, the light emitted from the light source and reaching the second surface to be totally reflected, and cause the light totally reflected by the second portion to exit from the first surface to the outside of the light-guiding plate.

4. The illumination device according to claim 3,
wherein the light-guiding plate is formed to cause the light totally reflected by the second portion to pass through the first surface.

5. The illumination device according to claim 2,
wherein, when a refractive index of the first coupling member and the second coupling member is set to n1, a refractive index of the light-guiding plate is set to n2, an angle of the light propagating in the light-guiding plate with respect to the display surface is set to α, an inclination angle of the second portion with respect to the display surface is set to β, and a reflection angle of the light totally reflected by the second portion with respect to the display surface is set to γ, α+β≤90°−arcsin(n1/n2), and γ≤α+2β are satisfied.

6. The illumination device according to claim 3,
wherein, when a refractive index of the first coupling member and the second coupling member is set to n1, a refractive index of the light-guiding plate is set to n2, an angle of the light propagating in the light-guiding plate with respect to the display surface is set to α, an inclination angle of the second portion with respect to the display surface is set to β, and a reflection angle of the light totally reflected by the second portion with respect to the display surface is set to γ, α+β≤90°−arcsin(n1/n2), and γ≤α+2β are satisfied.

7. The illumination device according to claim 4,
wherein, when a refractive index of the first coupling member and the second coupling member is set to n1, a refractive index of the light-guiding plate is set to n2, an angle of the light propagating in the light-guiding plate with respect to the display surface is set to α, an inclination angle of the second portion with respect to the display surface is set to β, and a reflection angle of the light totally reflected by the second portion with respect to the display surface is set to γ, α+β≤90°−arcsin(n1/n2), and γ≤α+2β are satisfied.
